(19) United States
(12) Patent Application Publication
(10) Pub. No.: US 2024/0377561 A1
(43) Pub. Date: Nov. 14, 2024

(54) IRIS DIAPHRAGM HAVING A PREDETERMINED SHAPE, WITHOUT SHAPE ROTATION

(71) Applicant: THALES, MEUDON (FR)

(72) Inventor: Laurent MONTAGNE, VILLEURBANNE (FR)

(21) Appl. No.: 18/693,938

(22) PCT Filed: Sep. 15, 2022
(86) PCT No.: PCT/EP2022/075610

§ 371 Date: Mar. 20, 2024

(30) Foreign Application Priority Data
Sep. 21, 2021 (FR) FR2109912

(51) Int. Cl. G02B 5/00

(52) U.S. Cl. CPC G02B 5/005

(57) ABSTRACT

An iris diaphragm having an optical axis, includes a fixed ring, a plurality of [Formula (I)] blades defining a diaphragm aperture of predetermined shape, the blades being able to move in a plane perpendicular to the optical axis with respect to the fixed ring, each blade comprising a control pin, a control ring designed to rotate about the optical axis with respect to the fixed ring and comprising m control guideways, each control pin being able to move along a respective one of the control guideways by bearing along the respective control guideway, a rotation of the control ring about the optical axis giving rise, via the movement of the control pins in the control guideways, to the movement of the blades with respect to the fixed ring so as to modify the area of the aperture while maintaining the predetermined aperture shape, without causing a rotation of the predetermined shape with respect to the fixed ring.

### CROSS-REFERENCE TO RELATED APPLICATIONS

This application is a National Stage of International patent application PCT/EP2022/075610, filed on Sep. 15, 2022, which claims priority to foreign French patent application No. FR 2109912, filed on Sep. 21, 2021, the disclosures of which are incorporated by reference in their entireties.

### FIELD OF THE INVENTION

The present invention relates to the field of iris diaphragms.

### BACKGROUND

The objectives of photographic equipment and cinematographic cameras are generally equipped with circular diaphragms arranged transversely with respect to the optical axis of the lenses. Circularity over all apertures is desirable in order to make best use of the quality of the objectives which are made up of spherical lenses with the least possible aberration in the recorded image.

In order to create these diaphragms it is possible to use a simple hole in a wall interposed in the path of the light or of several holes placed on a mobile element that enables succinct adjustment of the different aperture diameters.

Other optical systems that require greater compactness or a very large number of different aperture values employ an iris diaphragm, which allows continuous adjustment between its maximum aperture and its minimum aperture.

An iris diaphragm is made up of a set of blades the edge of which describes a regular polygon.

FIG. 1 shows an iris diaphragm PA of the prior art with an aperture O in a configuration A with a smaller aperture than configuration B. The iris diaphragm PA comprises a plurality of blades L typically made of metal or of plastic. In order to allow adjustment of the aperture size, each blade is for example connected to a ring R by a pivot connection the axis of which is perpendicular to the plane of the diaphragm or is translationally mobile with respect to the ring R. The controlled movement of the blades allows the aperture O to be decreased or increased. The aperture of an iris diaphragm is typically controlled by a peg T placed on the edge face of the ring of the diaphragm.

The number and shape of the blades that make up the iris is variable. The shape of this aperture will dictate the shape of out-of-focus background regions or bokeh. Thus, large-aperture objectives having a diaphragm made up of numerous (8 or 9) rounded blades permit bokeh effects of properly circular appearance and a sharper transition with the sharply focused zone. The higher the number of blades, the more closely the shape of the spots will conform to that of a perfect disk. Conversely, certain objectives produce pentagonal or hexagonal bokeh effects, depending on the number of blades that make up the diaphragm of the objective. The shape of the bokeh region may also be oval, depending on the optical design of the objective, and notably where use is being made of an anamorphic objective (for example in the case of cinematographic objectives).

Controlling the shape and orientation of the bokeh effects is important in certain applications (photography and cinema). In diaphragms of the prior art, the shapes rotate according to the aperture size of the diaphragm. This effect is undesirable.

### SUMMARY OF THE INVENTION

The invention aims to overcome certain problems of the prior art. Therefore a subject of the invention is an iris diaphragm of predetermined shape having a structure suitable for defining an aperture that produces a bokeh effect of which the type of shape and the orientation do not change according to the diaphragm aperture size.

To this end, one subject of the invention is an iris diaphragm having an optical axis and comprising:
a fixed ring,
a plurality of m∈N>1 blades defining a diaphragm aperture of predetermined shape, the blades being able to move in a plane perpendicular to the optical axis with respect to the fixed ring, each blade comprising a control pin,
a control ring designed to rotate about the optical axis with respect to the fixed ring and comprising m control guideways, each control pin being able to move along a respective one of the control guideways by bearing along the respective control guideway,
a rotation of the control ring about the optical axis giving rise, via the movement of the control pins in the control guideways, to the movement, in the plane perpendicular to the optical axis, of the blades with respect to the fixed ring so as to modify the area of the aperture while maintaining the predetermined aperture shape, without causing a rotation of the predetermined shape with respect to the fixed ring.

According to the embodiment M1 of the invention, the fixed ring comprises a plurality of n∈N≥2m guidance guideways, and wherein each blade comprises two respective mobile pins each able to move in one of the respective guidance guideways by bearing along the respective guidance guideway, a shape of each guidance guideway being such that the rotation of the control ring about the optical axis causes each of the mobile pins to move along the guidance guideways and causes the blades to move with respect to the fixed ring. As a preference, m=2, and the predetermined shape being a cat's eye.

As a preference, in the embodiment M1, each blade is associated with two respective guidance guideways in which the two mobile pins of this blade are able to move.

As a preference, in the embodiment M1, the control pin of each blade is arranged between the two mobile pins of this blade.

As a preference, in the invention, the fixed ring and the control ring are configured to cause the control ring to rotate about the optical axis in a predetermined angular sector. As a preference, the fixed ring and the control ring are configured to define a maximum transverse dimension of the aperture.

As a preference, in the invention, the blades and the guidance guideways exhibit central symmetry with respect to the optical axis.

### BRIEF DESCRIPTION OF THE FIGURES

Other features, details and advantages of the invention will become apparent on reading the description given with reference to the appended drawings, which are given by way of example and in which, respectively:

FIG. 1 is a schematic view of an iris diaphragm of the prior art,

FIG. 2 is an exploded view of a diaphragm according to one embodiment of the invention,

FIG. 3A, FIG. 3B, FIG. 3C are face-on views of the fixed ring and of the blades of a diaphragm according to one embodiment of the invention, for different diaphragm aperture sizes,

FIG. 4A, FIG. 4B, FIG. 4C are face-on views of a diaphragm according to one embodiment of the invention, the different diaphragm aperture sizes,

FIG. 5 is an exploded view of a diaphragm according to one embodiment of the invention,

FIG. 6A, FIG. 6B, FIG. 6C are face-on views of the fixed ring and of the blades of a diaphragm according to one embodiment of the invention, for different diaphragm aperture sizes.

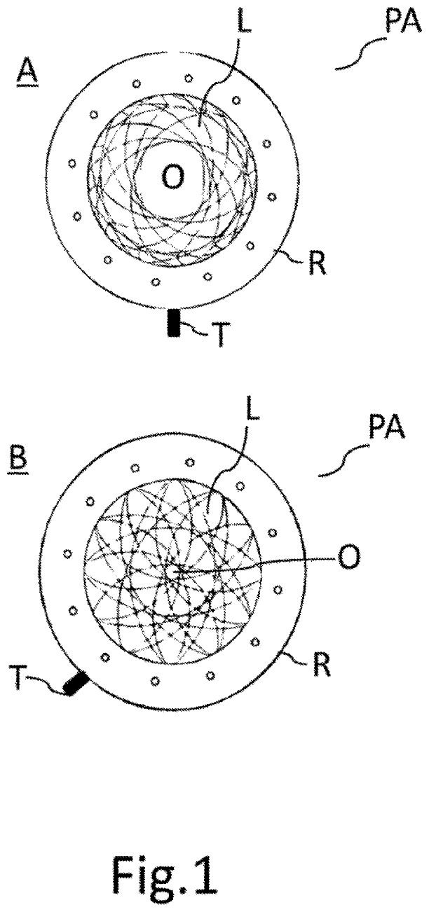

In the figures, unless otherwise indicated, the elements have been drawn to scale.

### DETAILED DESCRIPTION

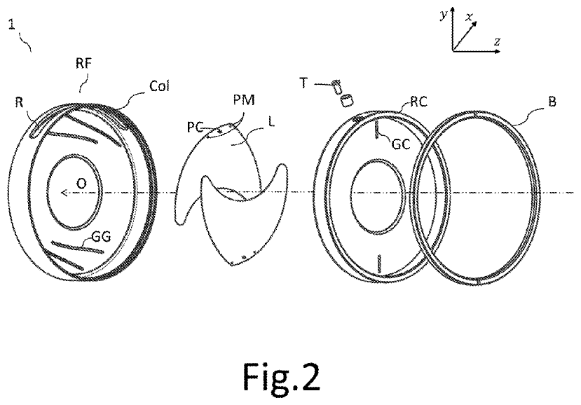

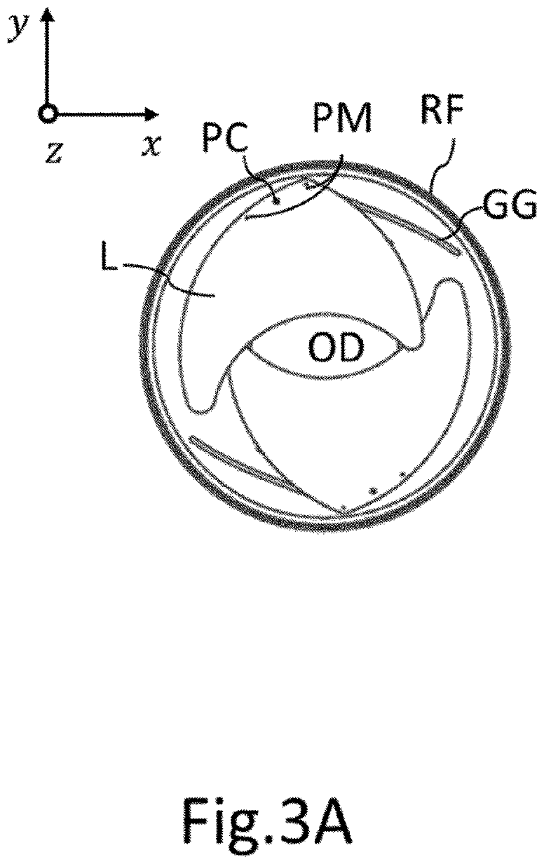

FIG. 2 schematically illustrates an exploded view of an iris diaphragm 1 according to the invention, particularly suited to camera objectives or photography objectives. The configuration illustrated in this figure, referred to as embodiment M1 hereinafter, is provided by way of nonlimiting example and may be modified according to the variants obvious to a person skilled in the art without departing from the scope of the invention.

The diaphragm 1 comprises a fixed ring RF which constitutes the only element of the diaphragm to remain immobile with respect to the optical axis O of the diaphragm. This is the element with respect to which the other parts of the diaphragm 1 will move. In the illustration of FIG. 2, by way of example, the optical axis O is perpendicular to the plane xy of the diaphragm and is in the direction z.

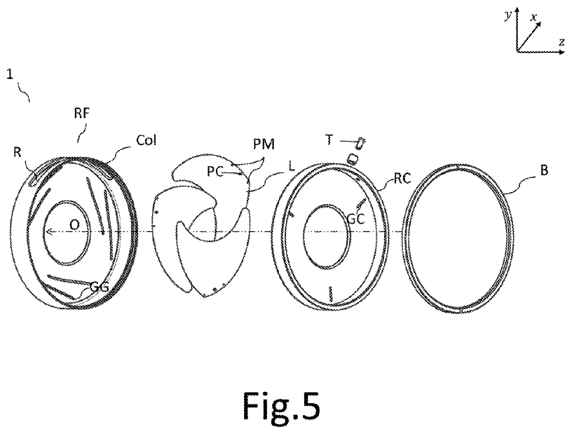

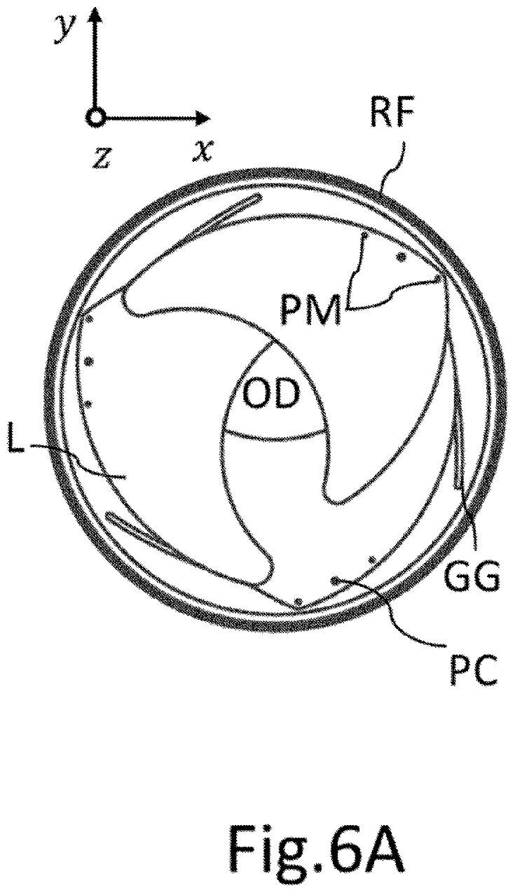

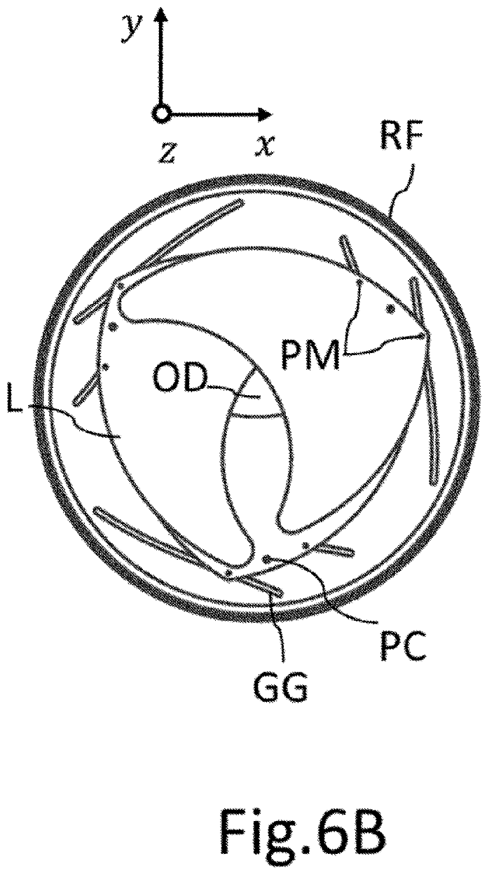

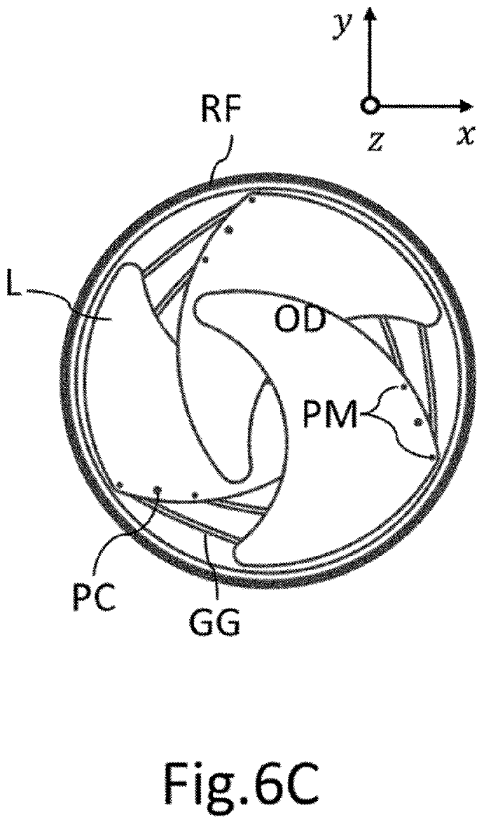

The diaphragm comprises a plurality of m∈N>1, which is to say at least two, blades L the edge of which describes segments of curves, the blades together defining an aperture OD in the shape of a regular polygon. In the invention, the blades define a diaphragm aperture OD of predetermined shape. By way of nonlimiting example, in the embodiment M1 illustrated in FIG. 2, the diaphragm 1 comprises m=2 blades and the predetermined shape of the aperture is a “cat's eye”, namely a shape defined by the intersection of two arcs of a circle or arcs of an ellipse. Alternatively, according to another embodiment, the diaphragm 1 comprises m>2 blades and the predetermined shape of the aperture is more complex (see for example FIGS. 5 to 6C).

With due consideration to the predetermined shape of the aperture OD, the bokeh effect obtained using the diaphragm of the invention will itself also have the same predetermined shape.

In order to be able to modify the aperture size, in the diaphragm of the invention, each blade is able to move in a plane perpendicular to the optical axis with respect to the fixed ring. As will be explained later on, this movement can be brought about in different ways. Further, each blade comprises a control pin PC. What is meant by “comprising a pin” is that the control pin PC is attached to the respective blade L or, in other words, that the control pin PC is set into the respective blade L.

Finally, the diaphragm 1 comprises a control ring RC designed to rotate about the optical axis with respect to the fixed ring RF. The control ring RC is the element of the diaphragm that allows the control pins PC to be made to move relative to the fixed ring RF. In order to do that, the control ring comprises as many control guideways GC as there are blades and each control pin PC is able to move in a respective one of the control guideways by bearing along the respective control guideway. Thus, the rotation of the control ring RC brings about the movement of the control pins PC in the control guideways GC. The layout and movement of the various elements of the diaphragm of the embodiment M1 can be seen in FIGS. 2 to 4C.

Unlike in the iris diaphragm of the prior art, the aperture OD of the diaphragm 1 of the invention produces a bokeh effect of which the type of shape and the orientation do not change according to the diaphragm aperture size. It is therefore necessary for the shape and the orientation of the aperture OD to remain identical irrespective of the aperture size of the diaphragm of the invention. To achieve that, a rotation of the control ring RC about the optical axis gives rise, via the movement of the control pins PC in the control guideways, to the movement, in the plane perpendicular to the optical axis, of the blades with respect to the fixed ring so as to modify the area of the aperture while maintaining the predetermined aperture shape, without causing a rotation of the predetermined shape with respect to the fixed ring. What is meant here by “maintaining the predetermined shape” is that increasing or decreasing the diaphragm aperture size keeps the aperture OD in the same type of shape and only the area of the aperture changes.

According to the embodiment M1, it is the guidance guideways GG that cause the blades to move with respect to the fixed ring RF. More specifically, the fixed ring RF comprises a plurality of n∈N≥2m, which is to say at least 4, guidance guideways GG, and each blade comprises two respective mobile pins PM each able to move in one of the respective guidance guideways GG by bearing along the respective guidance guideway. Thus, the shape of each guidance guideway is such that the rotation of the control ring RC about the optical axis causes each of the mobile pins PM to move along the guidance guideways GG and causes the blades to move with respect to the fixed ring. Alternatively, according to another embodiment, the position of the mobile pins and of the guidance guideways is reversed, which is to say that the guidance guideways are comprised in the blades and the mobile pins are comprised in the fixed ring.

It must be understood that the invention is not restricted to the guidance guideway shapes illustrated in FIGS. 2 to 4C, but covers all shapes of guidance guideway so long as they allow the desired effect, namely that of maintaining the shape and orientation of the aperture, to be obtained. In light of the description of the invention and of the figures, a person skilled in the art will know how to adapt the shape of the guidance guideways and that of the blades without an unreasonable amount of trial and error. The key point of the invention is that the use of the guidance guideways for guiding the movement of the mobile pins of the blades and therefore causing the blades to move with respect to the fixed ring, coupled with a control ring for causing the mobile pins to move, allows the aperture shape and orientation to be maintained.

The number of mobile pins PM per blade is preferably equal to two, so as to avoid obtaining a system that is statically indeterminate. Thus, each blade is associated with two respective guidance guideways in which the two mobile pins of this blade are able to move. Further, in order to limit the mechanical stresses as the mobile pins move in the guidance guideways, the control pin of each blade is preferably arranged between the two mobile pins of this blade.

As a preference, the blades L are arranged in such a way as to extend substantially in a plane perpendicular to the optical axis (and therefore parallel to the plane xy of the fixed ring RF). In practice, the blades L overlap and slide over one another. Each blade L extends in the plane xy. The blade thickness is very small compared to the blade dimensions in the plane xy. The aperture OD may be considered also to extend in the plane xy. In the embodiment M1, the blades and the guidance guideways exhibit central symmetry with respect to the optical axis.

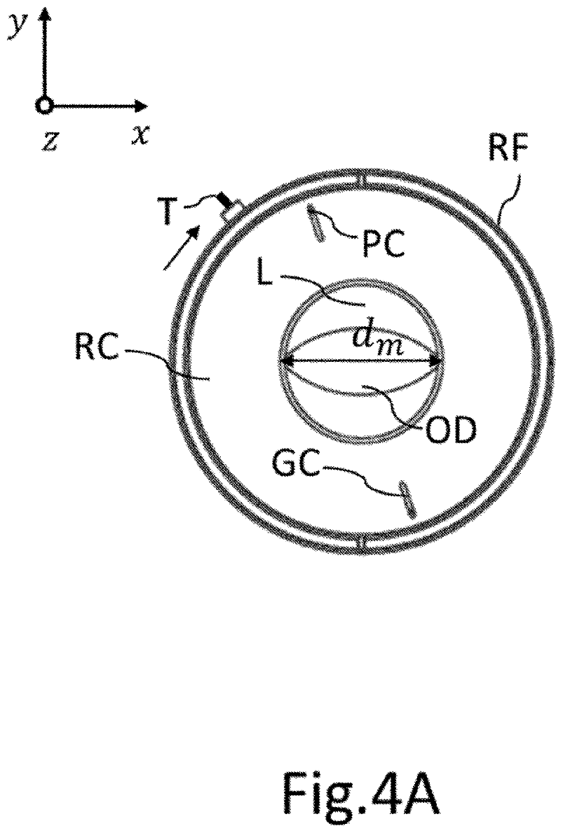

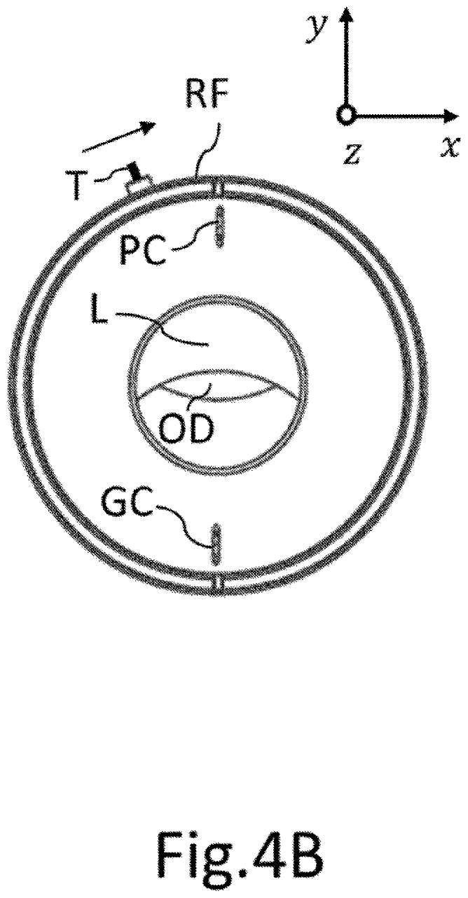

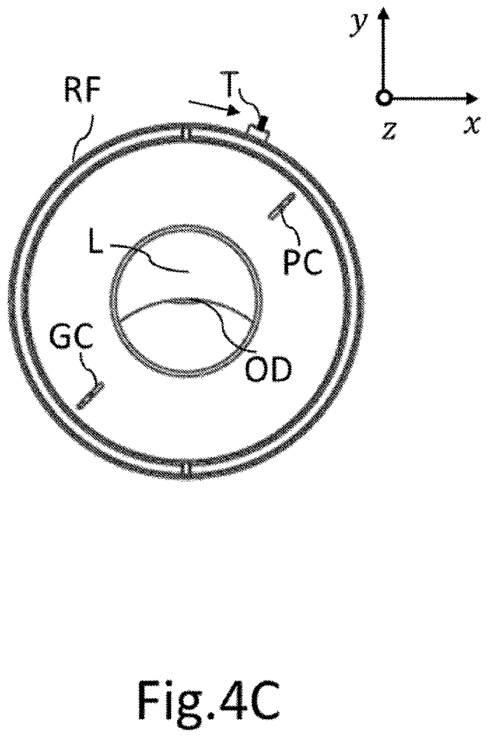

According to one preferred embodiment of the invention, the fixed ring RF and the control ring RC are configured to cause the control ring to rotate about the optical axis in a predetermined angular sector. By way of nonlimiting example, in the diaphragm of embodiment M1 of FIG. 2, the fixed ring RF comprises a collar Col exhibiting a slot R. In addition, the diaphragm comprises a peg T secured to the control ring and able to move in the slot by bearing along the slot. The length of the travel of the peg T in the slot R fixes the amplitude of possible angular rotation of the control ring RC and therefore limits the maximum and minimum aperture size that the aperture OD can achieve. FIG. 2 illustrates the fact that the action by the user on the peg T, indicated by an arrow in FIGS. 4A to 4C, allows the control ring to be rotated and the control pin to be moved in the control guideway. Alternatively, according to another embodiment, rotation is achieved by a rotary knob, for example offset on the collar.

The diaphragm of FIG. 2 further comprises a retaining ring B secured to the collar and designed to keep the elements RF, L and RC close to one another without restricting the rotation of the ring RC with respect to the ring RF. More specifically, the retaining ring B prevents translational movement of the ring RC along the optical axis O with respect to the fixed ring RF. The retaining ring B is produced for example in the form of an internal circlip fitted into a groove in the collar Col.

The rings RF, RC are made from a material that is diffusing with respect to visible light, for example anodized aluminum colored black and then coated with a matt black lubricant treatment that reduces unwanted light.

In the diaphragm stack of the embodiment M1, the blades are arranged between the control ring and the fixed ring. This mechanical design is the simplest for allowing the mobile pins of the blades to move in the guidance guideways. Further, this design allows the blades to be partially protected by the rings RC and RF.

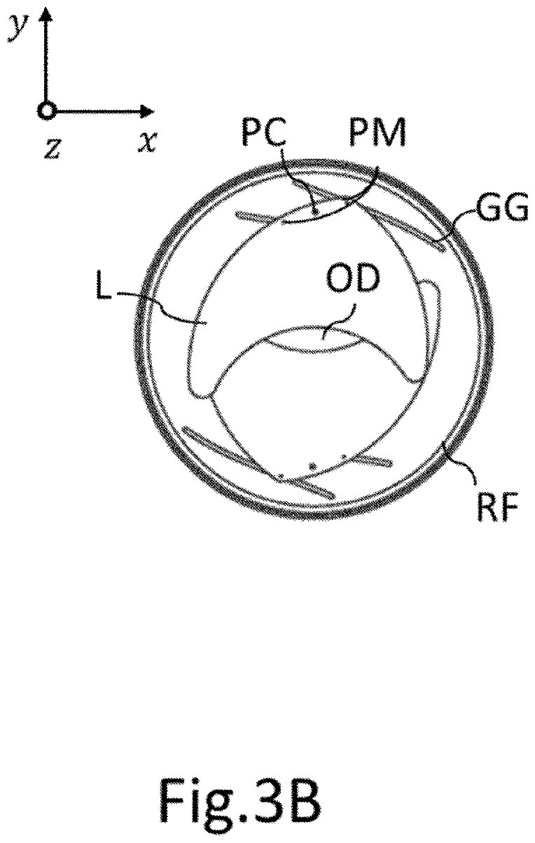

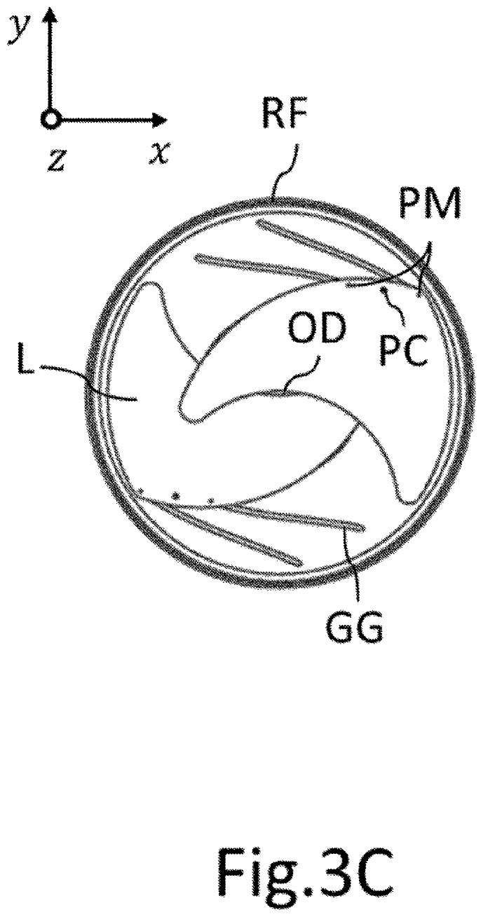

FIGS. 3A to 4C are depictions of the various elements of the diaphragm of the embodiment M1 illustrated in FIG. 2. As explained previously, the depictions are given by way of nonlimiting example and the embodiment M1 illustrated in these figures may be modified according to variants that are obvious to a person skilled in the art, without departing from the scope of the invention.

FIGS. 3A to 3C illustrate a face-on view of the fixed ring RF and of the blades L of the diaphragm of the embodiment M1 for different diaphragm aperture sizes (ranging from the maximum aperture size in the case of FIG. 3A to the minimum aperture size in the case of 3C). These figures provide an illustration of how the blades move with respect to the fixed ring according to the aperture size, this movement being brought about by the movement of the mobile pins along the guidance guideways GG.

FIGS. 4A to 4C illustrate a face-on view of the diaphragm of the embodiment M1 for different diaphragm aperture sizes (ranging from the maximum aperture size in the case of FIG. 4A to the minimum aperture size in the case of 4C). The diaphragm of the embodiment M1 comprises a stack formed of the fixed ring RF, blades L, the control ring RC and a retaining ring B designed to hold the stack in place under the collar Col. These figures show how the movement of the peg T in the slot R causes the control ring to rotate and the control pins to move in the control guideways GC and brings about the movement of the mobile pins along the guidance guideways GG.

In order for the shape of the aperture formed by the diaphragm to remain the predetermined shape from the largest to the smallest diaphragm aperture size, it is necessary for the aperture OD formed by the blades not to be truncated by either one of the rings RC and RF. That means to say that it is necessary for the rings RC and RF to have a central opening that defines a maximum transverse dimension (in the plane xy) of the diaphragm aperture. This maximum transverse dimension dm is illustrated in FIG. 4A which corresponds to the maximum diaphragm aperture configuration. In the embodiment M1, the slot R limits the travel of the peg T so that the rotation of the control ring RC about the optical axis occurs in a predetermined angular sector that is such that dm is equal to the diameter of the opening in the rings RC and RF.

FIG. 5 schematically illustrates an exploded view of an iris diaphragm 1 according to an embodiment M2 of the invention. In this embodiment, by way of nonlimiting example, the diaphragm comprises m=3 blades and the fixed ring RF comprises n=6 guidance guideways GG. Thus, the aperture formed by the blades (and therefore the bokeh effect) has a substantially triangular shape. As in the embodiment M1, each blade comprises a control pin PC, which implies that the control ring RC comprises three control guideways GC (one for each control pin).

FIGS. 6A to 6C illustrate a face-on view of the fixed ring RF and of the blades L of the diaphragm of the embodiment M2 for different diaphragm aperture sizes (ranging from the maximum aperture size in the case of FIG. 6A to the minimum aperture size in the case of 6C). These figures provide an illustration of how the blades move with respect to the fixed ring according to the aperture size, this movement being brought about by the movement of the mobile pins along the guidance guideways GG.

According to other embodiments of the invention it is possible to conceive of diaphragms having a number of blades greater than three in order to define more complex aperture, and therefore bokeh, shapes.

1. An iris diaphragm having an optical axis (O), comprising:
a fixed ring (RF),
a plurality of m∈N>1 blades (L) defining a diaphragm aperture (OD) of predetermined shape, the blades being able to move in a plane perpendicular to the optical axis with respect to the fixed ring, each blade comprising a control pin (PC),
a control ring (RC) designed to rotate about the optical axis with respect to the fixed ring and comprising m control guideways (GC), each control pin (PC) being able to move along a respective one of the control guideways by bearing along the respective control guideway,
a rotation of the control ring (RC) about the optical axis giving rise, via the movement of the control pins (PC) in the control guideways, to the movement, in the plane perpendicular to the optical axis, of the blades with respect to the fixed ring so as to modify the area of the aperture while maintaining the predetermined aperture shape, without causing a rotation of the predetermined shape with respect to the fixed ring,
the fixed ring further comprising a plurality of n∈N≥2m guidance guideways (GG), each blade comprising two respective mobile pins (PM) each able to move in one of the respective guidance guideways (GG) by bearing along the respective guidance guideway,
a shape of each guidance guideway being such that the rotation of the control ring (RC) about the optical axis causes each of the mobile pins (PM) to move along the guidance guideways (GG) and cause the blades to move with respect to the fixed ring.

2. The diaphragm as claimed in claim 1, wherein each blade is associated with two respective guidance guideways in which the two mobile pins of this blade are able to move.

3. The diaphragm as claimed in claim 2, wherein the control pin of each blade is arranged between the two mobile pins of this blade.

4. The diaphragm as claimed in claim 2, comprising m=2 blades, said predetermined shape being a cat's eye.

5. The diaphragm as claimed in claim 1, wherein the fixed ring and the control ring are configured to cause the control ring to rotate about the optical axis in a predetermined angular sector.

6. The diaphragm as claimed in claim 5, wherein the fixed ring and the control ring are configured to define a maximum transverse dimension of the aperture.

7. The diaphragm as claimed in claim 1, wherein the plurality of blades is arranged between the fixed ring and the control ring.

8. The diaphragm as claimed in claim 1, wherein the blades and the guidance guideways exhibit central symmetry with respect to the optical axis.
